(19) United States
(12) Patent Application Publication
(10) Pub. No.: US 2025/0307812 A1
(43) Pub. Date: Oct. 2, 2025

(54) Automated Management of Electric Vehicle Charging Sessions

(71) Applicant: Juice Serve, Inc,, Sunnyvale, CA (US)

(72) Inventors: James Murfin, London (GB); Taehyun Park, San Jose, CA (US)

(73) Assignee: Juice Serve, Inc., Sunnyvale, CA (US)

(21) Appl. No.: 19/075,487

(22) Filed: Mar. 10, 2025

Related U.S. Application Data
(60) Provisional application No. 63/563,840, filed on Mar. 11, 2024.

(51) Int. Cl. G06Q 20/40; B60L 53/65; B60L 53/66; G06Q 20/14

(52) U.S. Cl. CPC G06Q 20/40; B60L 53/65; B60L 53/665; G06Q 20/14

(57) ABSTRACT

Systems and methods for managing electric vehicle charging sessions may include one or more server computers and a charging station with at least one camera. The server computers receive a first image of a vehicle from a user, extract identifiers from the image, and associate the identifiers with a payment method. The charging station captures a second image of the vehicle approaching and communicates it to the server. The server identifies the vehicle, instructs the charging station to initiate a charging session, processes payment, and notifies the user of the session status. The charging station charges the vehicle's battery and communicates session completion to the server. The system enables automated vehicle recognition, charging initiation, payment processing, and user notification for electric vehicle charging sessions.

### CROSS-REFERENCE TO RELATED APPLICATIONS

This application Claims priority to U.S. Provisional Application No. 63/563,840, titled “Automated Management of Electric Vehicle Charging Sessions,” filed Mar. 11, 2025, which is hereby incorporated by reference in its entirety.

### FIELD OF INVENTION

The present disclosure generally relates to the field of electric vehicle charging technology, and more specifically, to systems and methods for automated management of electric vehicle charging sessions using image recognition and machine learning techniques.

### BACKGROUND

Electric vehicles (EVs) have gained considerable popularity in recent years due to their environmental benefits and advancements in battery technology. As the number of EVs on the road increases, so does the demand for charging stations. These charging stations are typically equipped with various hardware and software components to facilitate the charging process.

One of the primary components of a charging station is the charging equipment itself, which is designed to deliver electrical energy to the vehicle's battery. This equipment often includes a variety of connectors to accommodate different types of electric vehicles. The charging process typically involves the user connecting their vehicle to the charging equipment, initiating a charging session, and then disconnecting the vehicle once the charging session is complete.

In addition to the charging equipment, many charging stations also include user interfaces, such as screens or mobile applications, to facilitate user interaction with the charging station. These interfaces typically provide information about the charging session, such as the amount of energy delivered, the cost of the charging session, and the status of the charging session. Some interfaces also allow users to initiate and conclude charging sessions, and to make payments for the charging sessions.

Payment for charging sessions is typically handled through a payment processing system. This system may be integrated with the user interface, or it may be a separate component. The payment processing system typically requires the user to provide a payment method, such as a credit card or a mobile payment app, which is then used to process the payment for the charging session.

Managing EV charging sessions has traditionally been a complex process involving multiple steps and interactions between the user, the charging station, and the payment processing system. This complexity has led to user frustration and inefficiencies in the charging process.

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for managing electric vehicle charging sessions is provided. The system includes one or more server computers and a charging station comprising or in communication with at least one camera. The one or more server computers are configured to receive a first image of a vehicle from a user, extract one or more identifiers from the first image, wherein the identifiers include at least one of the vehicle's make, model, color, and license plate, associate the extracted one or more identifiers with a payment method, receive a second image of the vehicle from the charging station, identify the vehicle based on the second image, instruct the charging station to initiate a charging session with the vehicle, process a payment for the charging session based on the payment method, and notify the user of a status of the charging session. The charging station is configured to automatically capture the second image, via the one or more cameras, of the vehicle approaching the charging station, communicate the second image to at least one of the one or more servers, charge a battery of the vehicle, during the charging session, in response to instructions received from the server, and communicate to the server that the charging session has stopped.

According to other aspects of the present disclosure, the system may include one or more of the following features. The one or more servers may use a machine learning algorithm to identify the vehicle associated with the second image. The machine learning algorithm may be trained to recognize at least one of the make, model, color, and license plate of the vehicle. The machine learning algorithm may be further configured to detect at least one of a queue, blockage, or security issue at the charging station. A mobile application on the user device may provide a user interface for capturing the first image and associating the vehicle with a payment method. The mobile application may notify the user upon conclusion of the charging session, the notification including information about the cost of the charging session and the payment method used. The server may be further configured to automatically notify an operator of the charging station when a non-electric vehicle is identified at the charging station.

The one or more server computers may be further configured to calculate an idle fee for the vehicle based on a duration of time the vehicle remains parked at the charging station without engaging in the charging process, and communicate the calculated idle fee to the user. The charging station may be further configured to monitor activity around the vehicle while it is parked at the charging station using the at least one camera, and communicate data related to the monitored activity to the one or more server computers. The one or more server computers may be further configured to analyze the data related to the monitored activity using artificial intelligence algorithms to detect suspicious activities or incidents involving the vehicle, and generate and send an alert to the user's mobile device when suspicious activities or incidents are detected.

According to another aspect of the present disclosure, a method for managing an electric vehicle charging session is provided. The method includes receiving, by one or more server computers, a first image of a vehicle from a user, extracting, by the one or more server computers, one or more identifiers from the first image, wherein the identifiers include at least one of the vehicle's make, model, color, and license plate, associating, by the one or more server computers, the extracted one or more identifiers with a payment method, automatically capturing, by at least one camera at the charging station, a second image of the vehicle approaching a charging station, communicating, by the charging station, the second image to at least one of the one or more server computers, receiving, by the one or more server computers, the second image of the vehicle from the charging station, identifying, by the one or more server computers, the vehicle based on the second image, instructing, by the one or more server computers, the charging station to initiate a charging session with the vehicle, charging, by the charging station, a battery of the vehicle during the charging session in response to instructions received from the one or more server computers, communicating, by the charging station to the one or more server computers, that the charging session has stopped, processing, by the one or more server computers, a payment for the charging session based on the payment method, and notifying, by the one or more server computers, the user of a status of the charging session.

According to other aspects of the present disclosure, the method may include one or more of the following features. The method may include using, by the one or more server computers, a machine learning algorithm to identify the vehicle associated with the second image. The machine learning algorithm may be trained to recognize at least one of the make, model, color, and license plate of the vehicles. The method may include detecting, by the machine learning algorithm, at least one of a queue, blockage, or security issue at the charging station. The method may include providing, by a mobile application on a user device, a user interface for capturing the first image and associating the vehicle with a payment method. The method may include notifying, by the mobile application, the user upon conclusion of the charging session, the notification including information about the cost of the charging session and the payment method used. The method may include automatically notifying, by the one or more server computers, an operator of the charging station when a non-electric vehicle is identified at the charging station.

The method may include calculating, by the one or more server computers, an idle fee for the vehicle based on a duration of time the vehicle remains parked at the charging station without engaging in the charging process, and communicating, by the one or more server computers, the calculated idle fee to the user. The method may include monitoring, by the charging station, activity around the vehicle while it is parked at the charging station using the at least one camera, and communicating, by the charging station, data related to the monitored activity to the one or more server computers. The method may include analyzing, by the one or more server computers, the data related to the monitored activity using artificial intelligence algorithms to detect suspicious activities or incidents involving the vehicle, and generating and sending, by the one or more server computers, an alert to the user's mobile device when suspicious activities or incidents are detected.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system for managing electric vehicle charging operations, according to aspects of the present disclosure.

FIG. 2 illustrates an architecture for the system for managing electric vehicle charging operations, according to aspects of the present disclosure.

FIG. 3 depicts a flowchart for managing electric vehicle charging sessions, according to an embodiment.

FIG. 4A shows a mobile device user interface for capturing a vehicle image during registration, according to aspects of the present disclosure.

FIG. 4B illustrates a mobile device user interface for confirming vehicle identification and payment information, according to an embodiment.

FIG. 4C presents a mobile device user interface displaying successful registration confirmation, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure pertains to systems and methods for managing electric vehicle charging sessions. More specifically, the disclosure may involve the use of image recognition and machine learning techniques to automate various aspects of the charging process, potentially enhancing user experience and operational efficiency.

In some embodiments, the disclosed methods and systems may involve capturing an image of a vehicle using a user's mobile device, extracting identifiers from the captured image, and associating these identifiers with a payment method. The identifiers may include, but are not limited to, the vehicle's make, model, color, and license plate.

In some embodiments, the system may automatically identify the vehicle at a charging station using a camera when the vehicle approaches the charging station. This automatic identification may facilitate the initiation and conclusion of a charging session, as well as the processing of a payment for the charging session based on the associated payment method.

Furthermore, the system may automatically notify the user of the status of the charging session, potentially enhancing the user's experience and convenience. In some instances, the system may also be configured to detect non-electric vehicles at the charging station and notify an operator of the charging station of such vehicles, thereby improving the efficiency and utilization of the charging station.

In some embodiments, the system may employ machine learning algorithms to extract identifiers from the captured image and identify vehicles at the charging station. These algorithms may be trained to recognize various vehicle characteristics, such as make, model, color, and license plate. In some cases, the algorithms may also be configured to detect queues, blockages, or security issues at the charging station, thereby enhancing the safety and efficiency of the charging station.

Overall, the disclosed systems and methods may provide a more seamless and user-friendly charging experience for electric vehicle users, while also improving the operational efficiency and safety of charging stations.

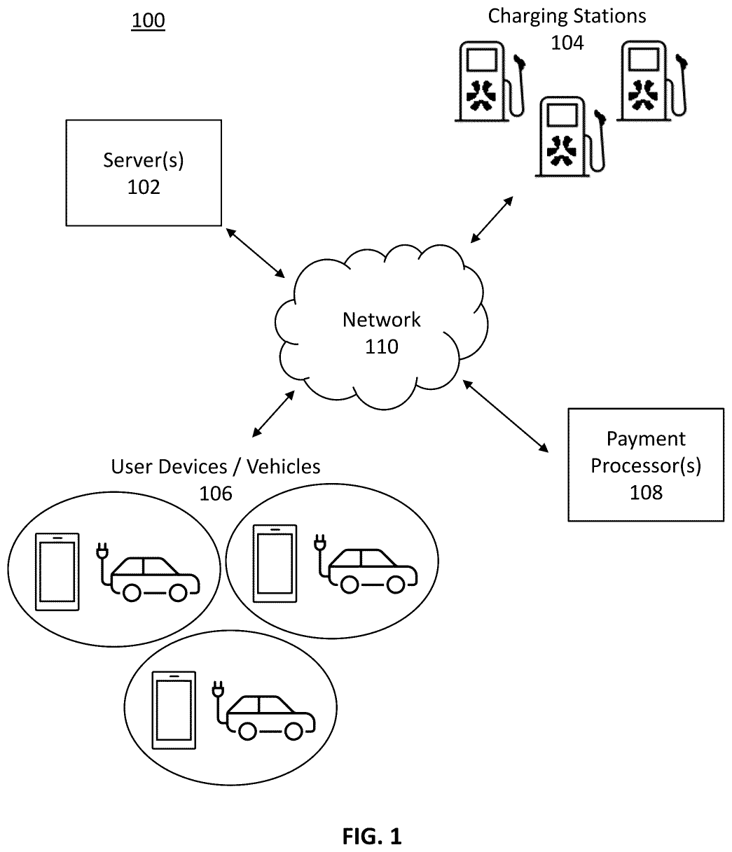

Referring to FIG. 1, a system 100 for managing electric vehicle charging operations is illustrated. The system 100 may include one or more server computers 102 connected to a network 110, which may facilitate communication between various components. Enhanced charging station(s) 104 may be connected to the network 110 and may be configured to provide charging services to electric vehicles. User devices and vehicles 106 may communicate with other system components through the network 110. Payment processor(s) 108 may be connected to the network 110 to handle transaction processing for charging services.

In some cases, the system 100 may use an Open Charge Point Protocol (OCPP) to communicate with the enhanced charging station(s) 104. This standardized protocol may allow for seamless integration and communication between the server(s) 102 and various types of charging stations.

The enhanced charging station(s) 104 may be equipped with one or more cameras. These cameras may be used for various purposes, such as vehicle identification and monitoring of the charging area. In some cases, the system 100 may also integrate with existing security cameras at charging sites, potentially enhancing the overall surveillance and security capabilities of the charging locations.

A prevalent issue at electric vehicle charging stations is the occurrence of ‘ICE-ing,’ a term derived from Internal Combustion Engine (ICE) vehicles. ICE-ing refers to the situation where non-electric vehicles occupy parking spaces designated for electric vehicle charging, thereby preventing access to the charging infrastructure for electric vehicle owners. This can be particularly problematic in areas where charging stations are scarce or during peak usage times, leading to frustration among electric vehicle drivers who depend on these stations to recharge their vehicles. Embodiments of system 100 may mitigate this issue by employing camera(s) to detect the presence of non-electric vehicles at the charging station(s) 104. For example, the server(s) 102 may use machine learning algorithms to detect whether a vehicle captured by camera(s) is a known electric vehicle or an ICE vehicle. Upon detection, the server(s) 102 can automatically notify an operator or other designated personnel (e.g., via text message, email, push notification, or other electronic means) to address the situation, ensuring that charging spots remain available for electric vehicles and improving the overall efficiency and user experience at the charging stations.

The server(s) 102 may be built on a cloud platform, such as Google Cloud Platform. This cloud-based architecture may provide scalability, reliability, and efficient data processing capabilities for the system 100.

For payment processing, the system 100 may utilize a secure payment processing service, such as Stripe. The payment processor(s) 108 may handle various aspects of transaction processing, including authorization, capture, and settlement of payments for charging services.

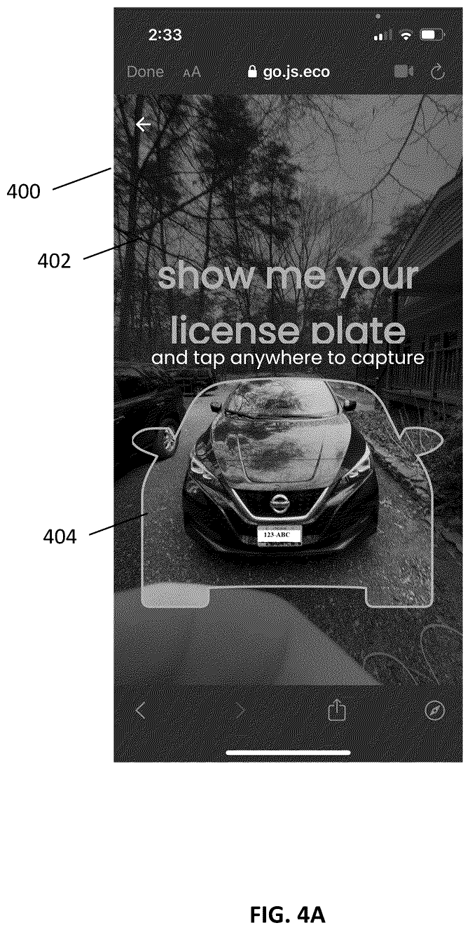

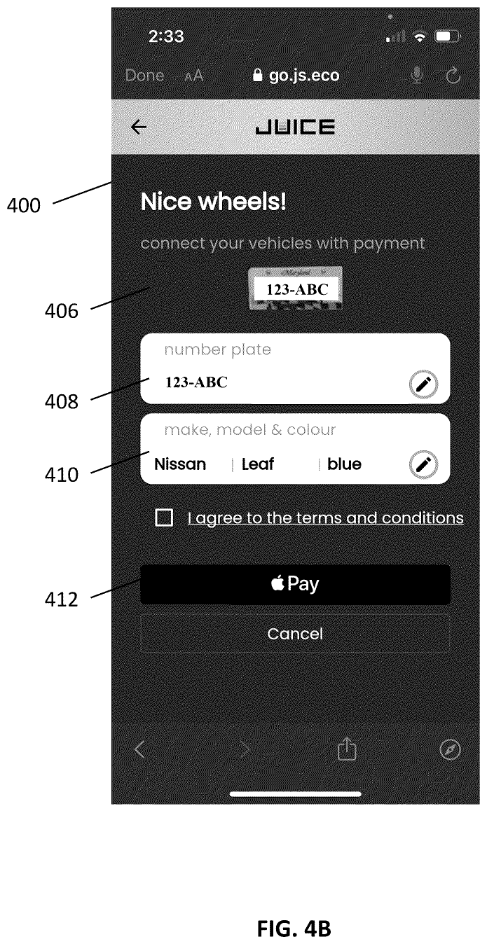

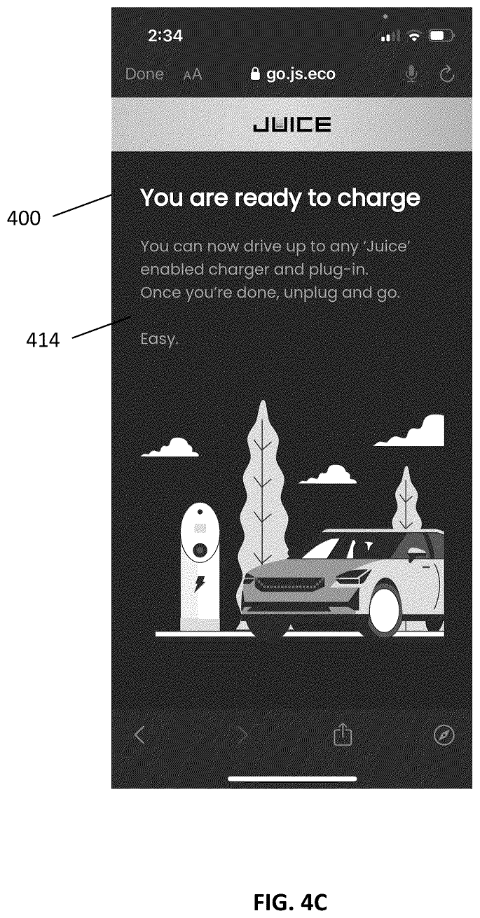

The user devices and vehicles 106 may interact with the system 100 through various interfaces, including those described with respect to FIGS. 4A, 4B, and 4C below. These interfaces may allow users to register their vehicles, initiate charging sessions, and receive notifications about their charging status.

By integrating these various components, the system 100 may provide a comprehensive solution for managing electric vehicle charging operations, from user registration to payment processing and charging session management.

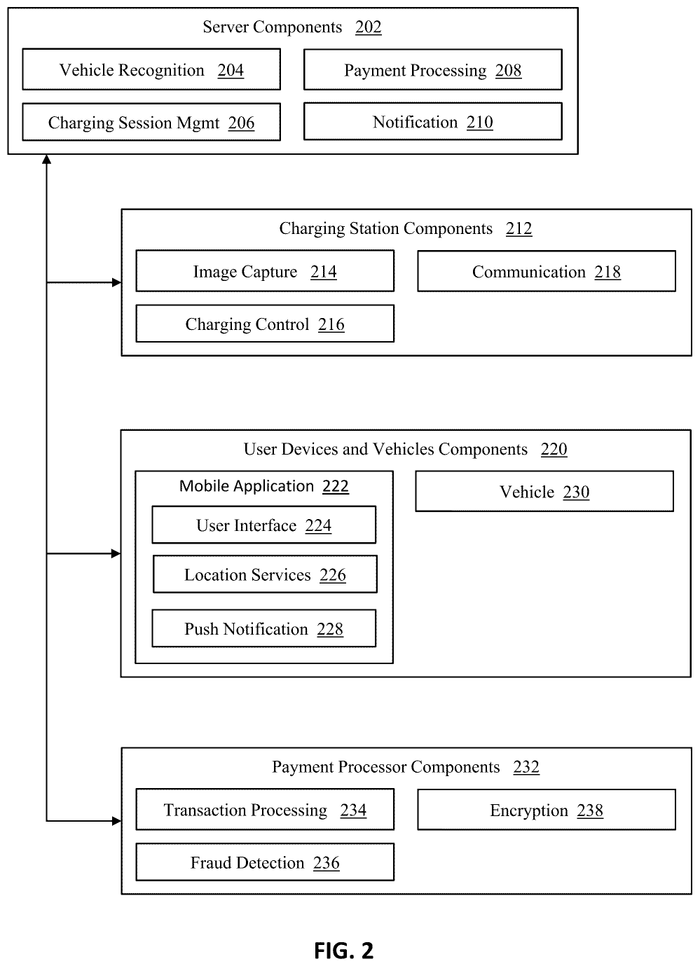

Referring to FIG. 2, an architecture 200 for the system 100 is illustrated. The architecture 200 may include various programmatic components implemented as software, firmware, or a combination thereof, distributed across the server(s) 102, enhanced charging station(s) 104, user devices and vehicles 106, and payment processor(s) 108. The software and firmware components of the system may be implemented as machine executable instructions that when executed by a processor may cause the corresponding module(s) to perform the functions described herein. The machine executable instructions may be stored in a non-transitory computer-readable medium, such as memory or storage devices, and may be loaded into the processor's memory for execution. In some cases, the instructions may be compiled or interpreted from high-level programming languages into a format that can be directly executed by the processor. This implementation strategy may enable efficient execution of the various functions of the system, including vehicle recognition, charging session management, payment processing, and user notifications.

The server(s) 102 may host several server components 202. These may include a vehicle recognition module 204, a charging session management module 206, a payment processing module 208, and a notification module 210. The vehicle recognition module 204 may utilize machine learning algorithms to process images received from the enhanced charging station(s) 104 and identify vehicles based on their make, model, color, and license plate. The charging session management module 206 may coordinate the initiation, monitoring, and conclusion of charging sessions. The payment processing module 208 may interface with the payment processor(s) 108 to handle financial transactions. The notification module 210 may generate and send alerts and updates to users and operators.

At the enhanced charging station(s) 104, charging station components 212 may include an image capture module 214, a charging control module 216, and a communication module 218. The image capture module 214 may manage the operation of the camera(s), capturing images of approaching vehicles and transmitting them to the server(s) 102. The charging control module 216 may regulate the flow of electricity to the vehicle during a charging session. The communication module 218 may facilitate data exchange with the server(s) 102, potentially using protocols such as OCPP.

User devices and vehicles 106 may incorporate user devices components 220 including mobile application components 222 and/or vehicle components 230. Mobile application components 222 may include a user interface module 224 for capturing vehicle images and displaying charging session information, a location services module 226 for identifying nearby charging stations, and a push notification module 228 for receiving updates. Vehicle components 230 may include onboard systems that communicate with the charging stations and mobile devices, potentially sharing battery status and charging preferences.

The payment processor(s) 108 may host payment processor components 232 including a transaction processing module 234, a fraud detection module 236, and an encryption module 238. These components may work together to securely handle financial transactions related to charging sessions.

All these components may interact via the network 110, which may serve as the communication backbone of the system 100. The network 110 may utilize various protocols and technologies to ensure reliable and secure data transmission between all parts of the system.

In some implementations, the architecture 200 may employ a microservices approach, where each component operates as an independent service. This architecture may allow for greater flexibility, scalability, and easier updates to individual components of the system.

The architecture 200 may also incorporate APIs (Application Programming Interfaces) that allow for integration with external systems. For example, the server components 202 may expose APIs that allow third-party applications to access charging station information or initiate charging sessions.

In some cases, the architecture 200 may include a data analytics component that collects and analyzes data from various parts of the system. This component may generate insights on charging station usage patterns, user behavior, and system performance, which may be used to optimize operations and improve user experience.

The components of the architecture 200 may be designed with redundancy and fault tolerance in mind. For instance, if one server becomes unavailable, the system may automatically route requests to backup servers to ensure continuous operation.

In some implementations, the architecture 200 may incorporate blockchain technology for secure and transparent record-keeping of charging sessions and payments. This may provide an additional layer of security and trust in the system's operations.

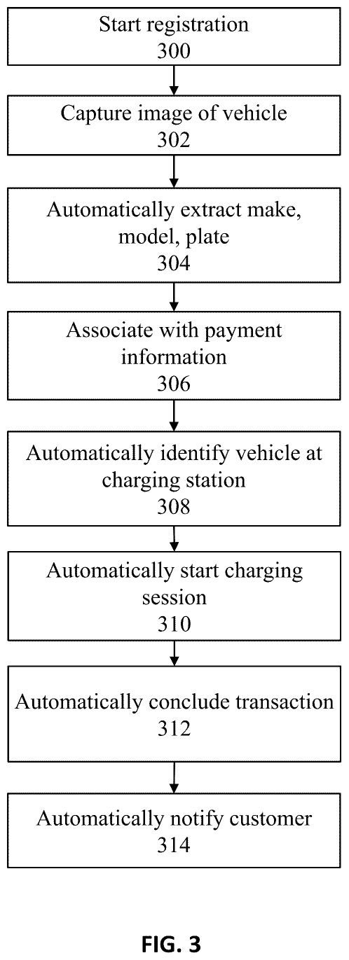

Referring to FIG. 3, a flowchart illustrating a process for managing electric vehicle charging sessions is depicted. The process may begin with a registration initiation 300. During the registration initiation 300, a user may initiate the registration process using the registration UI 400 on one of the user devices and vehicles 106.

Following the registration initiation 300, the process may proceed to an image capture 302. During the image capture 302, an image of a vehicle may be captured using one of the user devices and vehicles 106. In some cases, the image capture 302 may involve using a camera integrated into the user's mobile device.

After the image is captured, the process may proceed to an identifier extraction 304. During the identifier extraction 304, one or more identifiers may be automatically extracted from the captured image. The identifiers may be selected from the group comprising the vehicle's make, model, color, and license plate. In some cases, the server(s) 102 may use a machine learning algorithm to extract these identifiers.

Once the identifiers are extracted, the process may proceed to a payment association 306. During the payment association 306, the extracted identifiers may be automatically linked with a payment method. In some cases, the payment method may be associated with the extracted identifiers and a user profile through a secure payment processing system, which may involve the payment processor(s) 108.

Following the payment association 306, the process may proceed to a vehicle identification 308. During the vehicle identification 308, the vehicle may be automatically identified at one of the enhanced charging station(s) 104 when the vehicle approaches. The vehicle identification 308 may involve using a camera at the enhanced charging station(s) 104.

After the vehicle is identified, the process may proceed to a session initiation 310. During the session initiation 310, a charging session for the vehicle may be automatically started at one of the enhanced charging station(s) 104.

Following the session initiation 310, the process may proceed to a session conclusion 312. During the session conclusion 312, the charging session may be automatically concluded. In some cases, this may involve stopping the delivery of electrical energy to the vehicle's battery.

After the charging session is concluded, the process may proceed to a customer notification 314. During the customer notification 314, an automatic notification may be sent to the user to inform them of the status of the charging session. The notification may include information about the cost of the charging session, the amount of energy delivered, the duration of the charging session, and other relevant information. The notification may be sent via a text message, a push notification, an email, or any other suitable communication method.

In some cases, the system 100 may automatically process a payment for the charging session based on the payment method associated with the vehicle during the payment association 306. This payment processing may involve the payment processor(s) 108.

In some cases, the system 100 may be configured to automatically notify an operator of the enhanced charging station(s) 104 when a non-electric vehicle is identified at the charging station during the vehicle identification 308. This notification may help prevent unauthorized use of the charging stations and improve overall efficiency.

Referring to FIG. 4A, FIG. 4B, and FIG. 4C, a user interface for vehicle registration is depicted. The user interface may be part of a mobile application on the user devices and vehicles 106, providing a seamless process for capturing vehicle images, confirming identifiers, and completing registration.

FIG. 4A illustrates an image capture UI 402 that may be displayed on the user devices and vehicles 106. The image capture UI 402 may include a vehicle framing element 404, which may guide users in positioning their vehicle within the camera view for optimal image capture. In some cases, the vehicle framing element 404 may be an overlay or outline on the screen, helping users align their vehicle properly.

FIG. 4B shows an identifier confirmation UI 406 that may be presented after the image capture. The identifier confirmation UI 406 may include a plate confirmation element 408, where users can verify the automatically detected license plate number. In some cases, the plate confirmation element 408 may allow users to edit the license plate information if needed. The identifier confirmation UI 406 may also include a make and model confirmation element 410, displaying the detected vehicle make, model, and color for user verification. Additionally, a payment configuration element 412 may be present, allowing users to associate a payment method with their vehicle.

FIG. 4C depicts a successful registration UI 414, which may be displayed upon completion of the registration process. The successful registration UI 414 may provide confirmation to users that their vehicle has been successfully registered and associated with a payment method.

In some cases, the system 100 may use the registration process not only for electric vehicle charging but also for other services. For example, the system 100 may be adapted to work with a point-of-sale system located at a toll booth for automatic payment of toll fees. The camera(s) in the point-of-sale system may detect the presence of a registered vehicle and initiate the transaction process as the vehicle enters a predefined proximity zone.

In some cases, the system 100 may be used at drive-through service establishments such as fast-food restaurants, coffee shops, and pharmacies. The point-of-sale system with an integrated camera may identify registered vehicles and process payments automatically, providing a seamless experience for users.

The system 100 may also be utilized for curbside pickup services. In some cases, the system 100 may automatically notify stores when registered vehicles arrive, streamlining the pickup process.

In some cases, the system 100 may offer discounts or promotions to users for registering their vehicles, incentivizing adoption of the service.

The system 100 may also be adapted for use in parking garages. A point-of-sale system located at the parking garage may use the vehicle registration information for automatic payment of parking fees.

In all these scenarios, the system 100 may send a digital receipt of the transaction to the user's mobile device, providing a record of the transaction and enhancing user convenience.

In some cases, the system 100 may detect when a vehicle is parked in front of a charger without charging and notify an operator. The system 100 may identify a vehicle even before it stops at the charging station(s) 104, and prepare the charger for a charging session. The system 100 may select the right cable for charging based on the identified vehicle. The system 100 may notify a user that their vehicle that has been parked for a long time without charging.

In some embodiments, system 100 is configured to automatically calculate an idle fee for vehicles parked at a charging station. The idle fee is determined based on the duration of time that a vehicle remains parked without engaging in the charging process. The system can initiate the accrual of the idle fee from the moment the vehicle is detected to be parked at the charging station.

In some embodiments, the system 100 may utilize the camera(s) to monitor and analyze activity around a customer's vehicle while it is parked at the charging station(s) 104. The camera(s) may continuously capture video footage of the surrounding area, which is then processed by advanced AI algorithms running on the server(s) 102.

These AI algorithms may be trained to recognize various types of suspicious activities or incidents involving the vehicle. For instance, the system may be capable of identifying potential break-in attempts, acts of vandalism, or other unauthorized interactions with the vehicle. The AI may analyze factors such as the proximity of individuals to the vehicle, their behavior patterns, and any unusual movements or actions.

In cases where the system detects suspicious activity, it may automatically generate an alert. This alert may be sent to the customer via the mobile app on their user device(s) 106, potentially in the form of a push notification or text message. The notification may include details about the nature of the detected activity and may provide options for the customer to take immediate action, such as contacting local authorities or remotely activating the vehicle's alarm system.

The system may also be configured to detect and notify customers about non-security related incidents. For example, it may identify if another vehicle has accidentally bumped into the customer's car, if shopping carts or debris have collided with the vehicle, or if environmental factors like hail or falling branches pose a risk to the vehicle.

In some aspects, the system may offer a live video feed option, allowing customers to view their vehicle in real-time through the mobile app. This feature may provide additional peace of mind to customers, especially during longer charging sessions or in areas perceived as less secure.

Once the vehicle is parked, system 100 can continuously monitor its status to determine whether it is actively charging. If the vehicle is not charging, the idle fee continues to accrue. The fee accrual is paused during any periods in which the vehicle is actively charging, ensuring that the vehicle owner is not penalized while the vehicle is utilizing the services of the charging station. The calculation of the idle fee resumes if the vehicle ceases to charge before leaving the parking space. The total idle fee is then determined based on the cumulative time the vehicle was parked without charging, minus any periods of active charging. This fee can be communicated to the vehicle owner through the customer notification process described above.

In further embodiments, the system 100 may be adapted to facilitate seamless and touch-free transactions for goods and services beyond electric vehicle charging sessions. For instance, a user who has registered their vehicle with the system 100 and associated a payment method with that vehicle can leverage the same technology for other automated purchases. A practical application of this could be at a drive-through coffee shop, where a point-of-sale system replaces the vehicle charger. A camera integrated into the point-of-sale system could capture an image of the vehicle as it approaches, similar to the process at a charging station.

Upon capturing the vehicle's image, the point-of-sale system's camera communicates with the server(s) 102, which then identifies the vehicle using the previously stored identifiers, such as the make, model, color, and license plate. The server(s) 102, through integration with the point-of-sale system, can automatically process a payment for the user's order using the associated payment method. This process can occur without the user needing to physically interact with the payment terminal or staff, thereby providing a completely seamless and touch-free transaction experience.

Such embodiments may extend the utility of the system 100 to a variety of commercial transactions, enabling users to enjoy the convenience of automated payments in multiple contexts. This could include, but is not limited to, fast-food restaurants, toll booths, parking garages, or any other scenario where vehicle identification can be used to facilitate a transaction. The system's adaptability to different commercial environments demonstrates its versatility and potential for widespread application in automating and streamlining everyday transactions.

By leveraging the registration process and associated user interfaces, the system 100 may provide a versatile platform for various automated transactions, enhancing user convenience across multiple services beyond electric vehicle charging.

In some embodiments, the software, firmware, and computer-implemented methods described herein may be embodied as computer-executable instructions. These instructions may be stored on one or more non-transitory computer-readable storage media, such as hard drives, solid-state drives, optical discs, or flash memory devices. The computer-executable instructions, when executed by one or more processors, may cause the processors to perform the various operations and methods described in this disclosure.

The computer-executable instructions may be written in any suitable programming language, such as C, C++, Java, Python, or JavaScript. In some cases, the instructions may be compiled into machine code or bytecode before execution. The instructions may also be interpreted at runtime by an interpreter or virtual machine.

The system components, including the server(s) 102, enhanced charging station(s) 104, and user devices and vehicles 106, may each include one or more processors and memory storing the computer-executable instructions. When executed, these instructions may cause the respective components to perform their designated functions within the system 100.

For example, the vehicle recognition module 204, charging session management module 206, payment processing module 208, and notification module 210 may each be implemented as sets of computer-executable instructions stored in the memory of the server(s) 102. When executed by the server's processor(s), these instructions may cause the server to perform the respective functions of vehicle recognition, charging session management, payment processing, and user notification.

Similarly, the image capture module 214, charging control module 216, and communication module 218 in the enhanced charging station(s) 104 may be implemented as computer-executable instructions stored in the charging station's memory. These instructions, when executed by the charging station's processor(s), may enable the station to capture images, control the charging process, and communicate with other system components.

The mobile application components 222 on the user devices and vehicles 106, including the user interface module 224, location services module 226, and push notification module 228, may also be implemented as computer-executable instructions. These instructions may be stored in the device's memory and executed by its processor(s) to provide the user interface and functionality described herein.

In some implementations, the system 100 may utilize cloud computing resources. In such cases, some or all of the computer-executable instructions may be stored and executed on remote servers accessed over a network. This may allow for scalability and efficient resource allocation.

The computer-executable instructions may also include instructions for implementing the various algorithms described, such as the machine learning algorithms for vehicle recognition and the AI algorithms for monitoring vehicle surroundings. These may be implemented using existing machine learning and AI libraries or frameworks, or may be custom-developed for the specific needs of the system.

By embodying the described methods and functionalities as computer-executable instructions, the system 100 may provide a flexible and updateable platform. This may allow for easy maintenance, feature updates, and system improvements over time, potentially enhancing the overall performance and capabilities of the electric vehicle charging management system.

A number of implementations have been described. Nevertheless, it will be understood that various modifications may be made without departing from the spirit and scope of the disclosure. Accordingly, other implementations are within the scope of the following claims.

1. A system for managing electric vehicle charging sessions, the system comprising:
one or more server computers;
a charging station comprising or in communication with at least one camera;
wherein the one or more server computers are configured to:
receive a first image of a vehicle from a user;
extract one or more identifiers from the first image, wherein the identifiers include at least one of the vehicle's make, model, color, and license plate;
associate the extracted one or more identifiers with a payment method;
receive a second image of the vehicle from the charging station;
identify the vehicle based on the second image;
instruct the charging station to initiate a charging session with the vehicle;
process a payment for the charging session based on the payment method; and
notify the user of a status of the charging session; and
wherein the charging station is configured to:
automatically capture the second image, via the one or more cameras, of the vehicle approaching the charging station;
communicate the second image to at least one of the one or more servers;
charge a battery of the vehicle, during the charging session, in response to instructions received from the server; and
communicate to the server that the charging session has stopped.

2. The system of claim 1, wherein the one or more servers use a machine learning algorithm to identify the vehicle associated with the second image.

3. The system of claim 2, wherein the machine learning algorithm is trained to recognize at least one of the make, model, color, and license plate of the vehicle.

4. The system of claim 3, wherein the machine learning algorithm is further configured to detect at least one of a queue, blockage, or security issue at the charging station.

5. The system of claim 1, wherein the mobile application on the user device provides a user interface for capturing the first image and associating the vehicle with a payment method.

6. The system of claim 5, wherein the mobile application notifies the user upon conclusion of the charging session, the notification including information about the cost of the charging session and the payment method used.

7. The system of claim 1, wherein the server is further configured to automatically notify an operator of the charging station when a non-electric vehicle is identified at the charging station.

8. The system of claim 1, wherein the one or more server computers are further configured to:
calculate an idle fee for the vehicle based on a duration of time the vehicle remains parked at the charging station without engaging in the charging process; and
communicate the calculated idle fee to the user.

9. The system of claim 1, wherein the charging station is further configured to:
monitor activity around the vehicle while it is parked at the charging station using the at least one camera; and
communicate data related to the monitored activity to the one or more server computers.

10. The system of claim 9, wherein the one or more server computers are further configured to:
analyze the data related to the monitored activity using artificial intelligence algorithms to detect suspicious activities or incidents involving the vehicle; and
generate and send an alert to the user's mobile device when suspicious activities or incidents are detected.

11. A method for managing an electric vehicle charging session, the method comprising:
receiving, by one or more server computers, a first image of a vehicle from a user;
extracting, by the one or more server computers, one or more identifiers from the first image, wherein the identifiers include at least one of the vehicle's make, model, color, and license plate;
associating, by the one or more server computers, the extracted one or more identifiers with a payment method;
automatically capturing, by at least one camera at the charging station, a second image of the vehicle approaching a charging station;
communicating, by the charging station, the second image to at least one of the one or more server computers;
receiving, by the one or more server computers, the second image of the vehicle from the charging station;
identifying, by the one or more server computers, the vehicle based on the second image;
instructing, by the one or more server computers, the charging station to initiate a charging session with the vehicle;
charging, by the charging station, a battery of the vehicle during the charging session in response to instructions received from the one or more server computers;
communicating, by the charging station to the one or more server computers, that the charging session has stopped;
processing, by the one or more server computers, a payment for the charging session based on the payment method; and
notifying, by the one or more server computers, the user of a status of the charging session.

12. The method of claim 11, further comprising:
using, by the one or more server computers, a machine learning algorithm to identify the vehicle associated with the second image.

13. The method of claim 12, wherein the machine learning algorithm is trained to recognize at least one of the make, model, color, and license plate of the vehicles.

14. The method of claim 13, further comprising:
detecting, by the machine learning algorithm, at least one of a queue, blockage, or security issue at the charging station.

15. The method of claim 11, further comprising:
providing, by a mobile application on a user device, a user interface for capturing the first image and associating the vehicle with a payment method.

16. The method of claim 15, further comprising:
notifying, by the mobile application, the user upon conclusion of the charging session, the notification including information about the cost of the charging session and the payment method used.

17. The method of claim 11, further comprising:
automatically notifying, by the one or more server computers, an operator of the charging station when a non-electric vehicle is identified at the charging station.

18. The method of claim 11, further comprising:
calculating, by the one or more server computers, an idle fee for the vehicle based on a duration of time the vehicle remains parked at the charging station without engaging in the charging process; and
communicating, by the one or more server computers, the calculated idle fee to the user.

19. The method of claim 11, further comprising:
monitoring, by the charging station, activity around the vehicle while it is parked at the charging station using the at least one camera; and
communicating, by the charging station, data related to the monitored activity to the one or more server computers.

20. The method of claim 19, further comprising:
analyzing, by the one or more server computers, the data related to the monitored activity using artificial intelligence algorithms to detect suspicious activities or incidents involving the vehicle; and
generating and sending, by the one or more server computers, an alert to the user's mobile device when suspicious activities or incidents are detected.
